(19) United States
(12) Patent Application Publication
(10) Pub. No.: US 2016/0062034 A1
(43) Pub. Date: Mar. 3, 2016

(54) DISPLAY DEVICE

(71) Applicant: SHARP KABUSHIKI KAISHA, Osaka-shi, Osaka (JP)

(72) Inventors: Yoshinobu HIRAYAMA, Osaka-shi (JP); Masaki KAGEYAMA, Yonago-shi (JP)

(21) Appl. No.: 14/784,057

(22) PCT Filed: Feb. 27, 2014
(86) PCT No.: PCT/JP2014/054818

§ 371 Date: Oct. 13, 2015

(30) Foreign Application Priority Data
Apr. 18, 2013 (JP) 2013-087296

(51) Int. Cl. F21V 8/00

(52) U.S. Cl. CPC G02B 6/0088; G02B 6/005

(57) ABSTRACT

A liquid crystal display device 10 includes LEDs 22, a light guide plate 20, a metal chassis 28, an optical member 18, and a liquid crystal panel 14. The light guide plate 20 for guiding light from the LEDs 22 includes a front surface as a light-exit surface 20b, a rear surface as an opposite surface 20c, and a light-entering surface 20a facing the LEDs 22 as one of side surfaces. The chassis 28 including a bottom plate 28a opposite the opposite surface 20c and side plates 28b extending from corresponding edges of the bottom plate 28a toward the light-exit surface 20b holds the light guide plate 20. The side plates 28b except the light-entering surface 20a is near the corresponding side surfaces. The optical member 18 faces the light-exit surface 20b to add optical properties to light from the light-exit surface 20b. The liquid crystal panel 14 faces an opposite side of the optical member 18 from the light-exit surface 20b, and is fixed to an edge surface 28b2 of the side plates 28b with a panel-fixing adhesive 32.

### TECHNICAL FIELD

The present invention relates to a display device.

### BACKGROUND ART

In recent years, liquid crystal display devices are used as display devices included in electronic devices such as portable information terminals (mobile phones, smart phones, and tablet-type laptop computers). Such a liquid crystal display device includes a liquid crystal panel as a display panel for displaying images and a backlight device for supplying light to the liquid crystal panel. The liquid crystal panel includes a display area in which images are displayed and a non-display area around the display area. In the liquid crystal display device, the non-display area is defined as a frame portion of the liquid crystal display device. In the liquid crystal display device of this type, it may be required to reduce the width of the frame portion, that is, to reduce the frame size, for design purposes.

Patent document 1 discloses an electro-optic device having a smaller frame size. The electro-optic device includes a case that holds an electro-optic panel that is configured as a display panel. The case includes a stepped surface at an outer peripheral portion thereof and the electro-optic panel is supported by the step-tread surface. According to this configuration, the frame size of the electro-optic device is tried to be reduced.

### RELATED ART DOCUMENT

### Patent Document

Patent Document 1: Japanese Unexamined Patent Application Publication No. 2010-60591

### Problem to be Solved by the Invention

In the electro-optic device described in Patent document 1, a portion of the outer peripheral portion of the case including the stepped surface has a larger thickness than a tip portion of the case. Therefore, a width of a frame portion is increased by the width of the stepped surface. Further, the case is made of synthetic resin and it is difficult to reduce the thickness of the outer peripheral portion. Therefore, the frame size of the electro-optic device has not been effectively reduced.

### DISCLOSURE OF THE PRESENT INVENTION

The technology disclosed herein was made in view of the above circumstances. An object is to provide a technology to reduce a frame size of a display device.

### Means for Solving the Problem

A technology disclosed in the description relates to a display device including a light source, a light guide plate, a housing member made of metal, an optical member, and a display panel. The light guide plate includes a plate surface configured as a light exit surface, another plate surface as an opposite surface that is opposite from the light exit surface, and one of side surfaces configured as a light entering surface. The light guide plate is arranged such that the light entering surface faces the light source and configured to guide light from the light source. The housing member includes a bottom plate and side plates. The bottom plate has a plate-like shape and is opposite the opposite surface of the light guide plate. The side plates each having a plate-like shape extend from corresponding edges of the bottom plate toward the light exit surface. The housing member holds at least the light guide plate such that the side surfaces of the light guide plate except the light entering surface are adjacent to the corresponding side plates. The optical member is opposite the light exit surface and is configured to add optical properties to light passing through the light exit surface. The display panel is opposite a surface of the optical member opposite from a surface of the optical member facing the light exit surface and being fixed to at least one of the optical member and edges of the respective side plates of the housing member with an adhesive.

According to the display device, the light guide plate is arranged in the holding member such that the side surfaces thereof except the light entering portion are adjacent to the corresponding side plates. Thus, the light guide plate corresponds to a large area of the holding member. The display panel is arranged so as to be opposite the light exit surface of the light guide plate. Thus, a display area of the display panel corresponds to a larger area of the holding member. Further, the holding member is made of metal and thus the side plate is processed to have an effectively smaller thickness in the manufacturing process. Here, the adhesive agent is a shapeless material and thus can be applied on a portion having a small thickness. The display panel is fixed to at least one of the optical member and the edges of the respective side plates with the adhesive. Thus, although the side plate is a plate-like member having a small thickness, the display panel can be fixed to the side plate, which has a small width. Accordingly, the width of a portion of the display panel used for fixing is reduced, namely, the width of a non-display area of the display panel is reduced. As described above, in the display device, the width of the non-display area of the display panel is reduced while the display area of the display panel occupying in the area of the holding member is increased. Thus, the frame size of the display device is reduced.

The optical member may be fixed to the side plates.

According to this configuration, the optical member is not or less likely to be displaced and thus preferable optical properties are obtained.

The adhesive may be between the optical member and the display panel and on an inner side with respect to the side plates, and the optical member and the display panel may be fixed to the side plates via the adhesive.

According to this configuration, the adhesive to fix the display panel to the side plates can be used to an agent to fix the optical member to the side plates. Accordingly, space for an adhesive is saved. This further reduces the frame side of the display device.

One of the side plates may include a bent portion at the edge thereof. The bent portion protrudes inward. The optical member is held by the bent portions of the side plates.

According to this configuration, the optical member is fixed to the side plates without using adhesive.

The display device may further includes a protector on a surface of the display panel opposite from a surface of the display panel facing the optical member.

According to this configuration, in the display device including the display panel that is protected by the protector, the frame size of the display device is reduced.

The side plates may include overhanging portions at the edges thereof. The overhanging portion may protrude outward and the protector may be supported by the overhanging portion.

According to this configuration in which the side plates include the overhanging portions, each side plate allocates a sufficient area to support the protector. Thus, an agent such ad a double-sides tape, which is different from an adhesive, can be attached to the overhanging portions.

an entire surface of the liquid crystal panel may be bonded and fixed to the protector.

According to this configuration, adhesion strength between the liquid crystal panel and the protector remains a high level and thus the protector is less likely to be displaced from the liquid crystal panel.

The light source may be a side-emitting light source. The display device may further include a light source board that includes a plate surface on which the light source is arranged such that a light emitting surface of the light source faces the light entering surface. An edge portion of the plate surface of the light source board may be in contact with an edge portion of the light exit surface close to the light entering surface.

According to this configuration, a portion of the plate surface of the light source board is in contact with the light emitting surface and thus space for arranging the light source board is saved. Accordingly, the frame size of the display device is reduced.

One of the side plates may include a through hole. The light source board may be a flexible board having flexibility and may include an extending portion extending outward with respect to the housing member. The extending portion may be through the through hole.

According to this configuration, the frame size of the display device is reduces, whereas the extending portion of the light source board, which is the flexible board, is arranged so as to extend outward with respect to the housing member.

The adhesive may have light blocking properties. According to this configuration, light does not or is less likely to leak through a gap between the liquid crystal panel and the housing member, or a gap between the liquid crystal panel and the optical member.

In the technology disclosed herein, a display device including a liquid crystal panel using liquid crystals as the display panel has novelty and utility. Further, a television device including the above display device has novelty and utility.

### Advantageous Effect of the Invention

According to the technology disclosed in this specification, a frame size of a display device is reduced.

### BRIEF DESCRIPTION OF THE DRAWINGS

FIG. 1 is an exploded perspective view of a liquid crystal display device according to a first embodiment.

FIG. 2 is a cross-sectional view of the liquid crystal display device cut along a long-side dimension of a chassis.

FIG. 3 is a cross-sectional view of the liquid crystal display device cut along a short-side dimension of the chassis.

FIG. 4 is a side view of the liquid crystal display device, illustrating a short-side of the chassis.

FIG. 5 is a cross-sectional view of a liquid crystal display device according to a first modification of the first embodiment cut along a short-side dimension of a chassis.

FIG. 6 is a side view of the liquid crystal display device according to a second modification of the first embodiment, illustrating a short-side of a chassis.

FIG. 7 is an exploded perspective view of a liquid crystal display device according to a second embodiment.

FIG. 8 is a cross-sectional view of the liquid crystal display according to the second embodiment cut along a long-side dimension of a chassis.

FIG. 9 is a cross-sectional view of the liquid crystal display according to the second embodiment cut along a short-side dimension of the chassis.

FIG. 10 is a side view of the liquid crystal display device according to the second embodiment, illustrating a short-side of the chassis.

FIG. 11 is a cross-sectional view of a liquid crystal display according to a third embodiment cut along a long-side dimension of a chassis.

FIG. 12 is a cross-sectional view of the liquid crystal display according to the third embodiment cut along a short-side dimension of the chassis.

### MODE FOR CARRYING OUT THE INVENTION

### First Embodiment

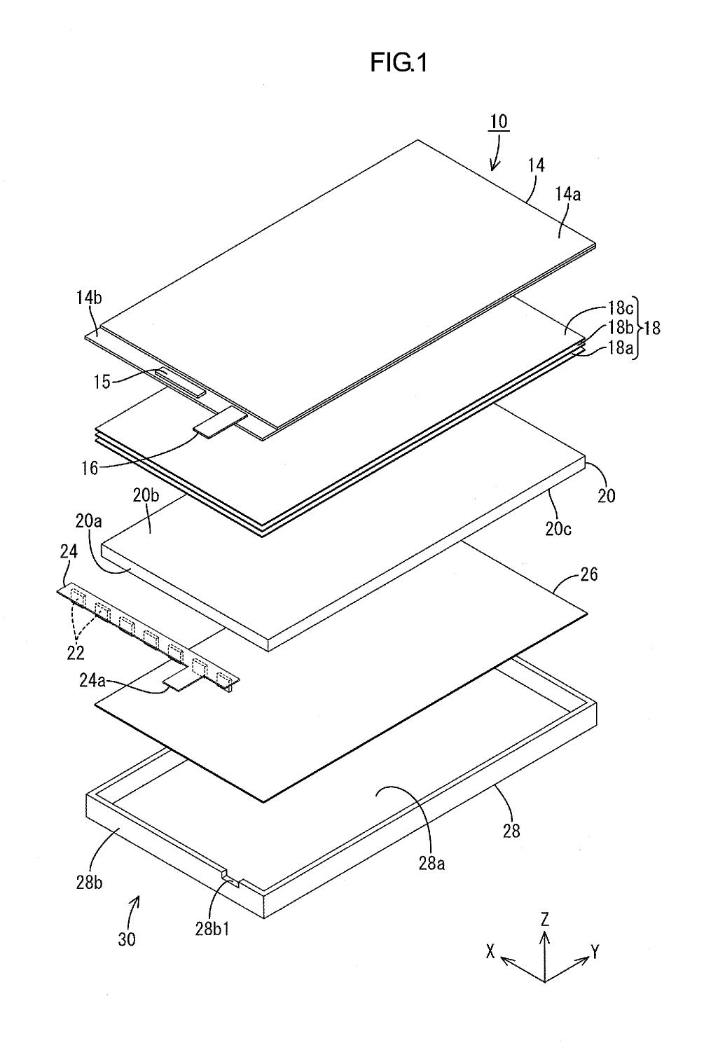

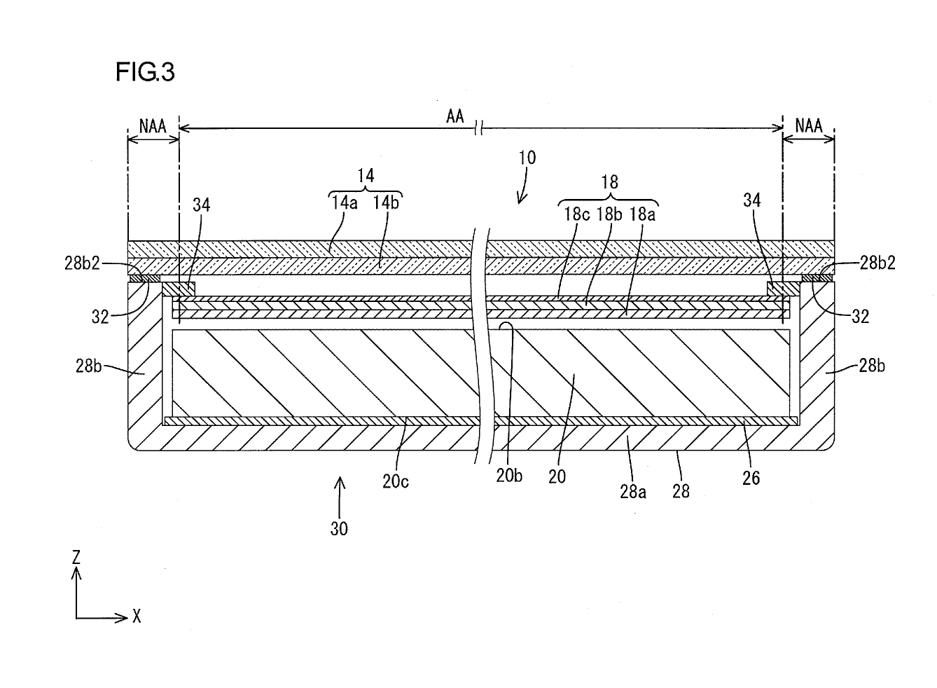

A first embodiment will be described with reference to the drawings. A liquid crystal display device (an example of a display device) 10 will be described in this description. X-axis, Y-axis and Z-axis may be indicated in the drawings. The axes in each drawing correspond to the respective axes in other drawings. The vertical direction in FIGS. 1 and 3 is defined as a reference. The upper side and the lower side in FIGS. 1 and 3 correspond to the front side and the rear side, respectively.

As illustrated in FIG. 1, the liquid crystal display device 10 has a rectangular and vertically long overall shape. The liquid crystal display device 10 includes a liquid crystal panel (a display panel) 14 and a backlight device (an example of a lighting device) 30 as an external light source. The liquid crystal panel 14 includes a front surface configured as a display surface for displaying images. The backlight device 30 is arranged on a side of the liquid crystal panel 14 opposite from the display surface and configured to supply light to the liquid crystal panel 14. The liquid crystal display device 10 according to this embodiment is disposed in a casing that provides an external configuration and used in electronic devices such as mobile information terminals (e.g., mobile phones, smart phones, tablet-type laptop computers), in-vehicle information terminals (e.g., stationary car navigation systems and portable car navigation systems), and portable video game players. The display size of the liquid crystal panel 14 included in the liquid crystal display device 10 is from several inches to a dozen inches. Namely, the liquid crystal panel 14 is generally classified as a small sized or a medium sized panel.

The liquid crystal panel 14 will be described. As illustrated in FIG. 1, the liquid crystal panel 14 has a rectangular and vertically long overall shape. The liquid crystal panel 14 includes a pair of transparent glass substrates 14a, 14b (having light transmissivity) and a liquid crystal layer (not illustrated) in between the substrates 14a and 14b. The liquid crystal layer contains liquid crystal molecules, which are substances that change optical characteristics when electromagnetic field is applied. The substrates 14a, 14b are bonded together with a sealing agent (not illustrated) with a gap therebetween. The gap corresponds to a thickness of the liquid crystal layer. One of the substrates 14a, 14b on the rear (a rear-surface side) is an array substrate 14b. The other one of the substrates 14a, 14b on the front (a front-surface side) is a CF substrate 14a. The array substrate 14b includes switching elements (e.g. TFTs), pixel electrodes, and an alignment film. The switching elements are connected to gate lines and source lines that are perpendicular to the gate lines. The pixel electrodes are connected to the switching elements. The CF substrate 14a includes color filters, counter electrodes, and an alignment film. The color filters include red (R), green (G), and blue (B) color portions that are arranged in a predetermined arrangement. As illustrated in FIG. 1, a short-side dimension of the CF substrate 14a is substantially equal to a short-side dimension of the array substrate 14b and a long-side dimension of the CF substrate 14a is smaller than a long dimension of the array substrate 14b. The CF substrate 14a is bonded to the array substrate 14b such that an end portion of the long-side dimension of the CF substrate 14a is aligned with a corresponding end portion of the array substrate 14b. Another end portion of the long-side dimension of the array substrate 14b is uncovered and a front surface and a rear surface of the end portion are exposed. The other end portion of the array substrate 14b is provided as a mounting area and a driver 15 and a panel flexible circuit board 16 are mounted thereon for driving the liquid crystal panel 14. Polarizing plates (not illustrated) are arranged on outer surfaces of the respective substrates.

Next, the backlight device 30 will be described. As illustrated in FIG. 1, the backlight device 30 includes a chassis (an example of a housing member) 28 having substantially a tray shape with an opening on the front side (a light exiting side, a liquid crystal panel 14 side). The liquid crystal panel 14 described earlier covers the opening of the chassis 28. Fixing structures of the liquid crystal panel 14 with respect to the chassis 28 will be described later. The chassis 28 provides a storage space therein and an optical member 18, alight guide plate 20, light emitting diode (LEDs) 22 as a light source, an LED flexible circuit board (an example of a light source board, a flexible circuit board) 24, and a reflection sheet 26 are arranged in the space. The LEDs 22 are mounted on the LED flexible circuit board 26.

The chassis 28 is formed from a metal plate, which may be an aluminum plate or an electro galvanized steel plate (SECC), and constitutes a rear exterior and side exteriors of the liquid crystal display device 10. The chassis 28 includes a bottom plate 28a and side plates 28b. The bottom plate 28a has a rectangular plate-like shape similar to the liquid crystal panel 14. The bottom plate 28a is opposite an opposite surface 20c of the light guide plate 20, which will be described later. The side plate 28b each having a plate-like shape extend upward from corresponding edges of the bottom plate 28a toward the front side (toward a light exit surface 20b of the light guide plate, which will be described later). As illustrated in FIG. 1, one of the side plates 28b of the chassis 28 includes a notch (an example of a through hole) 28b1 that is recessed from its distal end toward the bottom plate 28a. The notch 28b1 is through the side plate 28b. The chassis 28 is formed by sheet-metal-processing or press-processing and thus the thicknesses of the bottom plate 28a and the side plates 28b are significantly small (e.g. no more than 0.4 mm).

The reflection sheet 26 is a rectangular sheet made of synthetic resin and includes a white surface having a high light reflectivity. The reflection sheet 26 has a substantially the same size as the bottom plate 28a of the chassis 28. The reflection sheet 26 is on the bottom plate 28a and covers substantially an entire surface of the bottom plate 28a. Peripheral edges of the reflection sheet 26 are adjacent to the corresponding side plates 28b of the chassis 28. A large portion of the reflection sheet 26 is in surface-contact with the opposite surface 20c of the light guide plate 20, which will be described later. That is, the reflection sheet 26 is sandwiched between the light guide plate 20 and the bottom plate 28a of the chassis 28. The reflection sheet 26 is configured to reflect light that exits the LEDs 22 or light that exits the light guide plate 20 through the opposite surface 20c.

The light guide plate 20 is made of substantially transparent (high transmissivity) synthetic resin (e.g. acrylic resin or polycarbonate such as PMMA) which has a refractive index sufficiently higher than that of air. As illustrated in FIG. 1, the light guide plate 20 is a plate-like member having a rectangular shape in a plan view similar to the liquid crystal panel 14. A thickness of the light guide plate 20 is larger than a thickness of the optical member 18, which will be described later. A long-side dimension and a short-side dimension of plate surfaces of the light guide plate 20 correspond to the X-axis direction and the Y-axis direction, respectively. A thickness dimension of the light guide plate 20 that is perpendicular to the plate surfaces of the light guide plate 20 corresponds to the Z-axis direction. As illustrated in FIGS. 1 to 3, the light guide plate 20 is arranged directly below the liquid crystal panel 14 and the optical member 18, and is surrounded by the side plates of the chassis, which will be described later. As illustrated in FIGS. 1 to 3, one of the plate surfaces of the light guide plate 20 on the front is a light exit surface 20b (a surface facing the liquid crystal panel 14 and the optical member 18). Light in the light guide plate 20 exits the light guide plate 20 through the light exit surface 20b toward the optical member 18 and the liquid crystal panel 14. The other one of the plate surfaces of the light guide plate 20 opposite from the light exit surface 20b (a rear surface) is the opposite surface 20c.

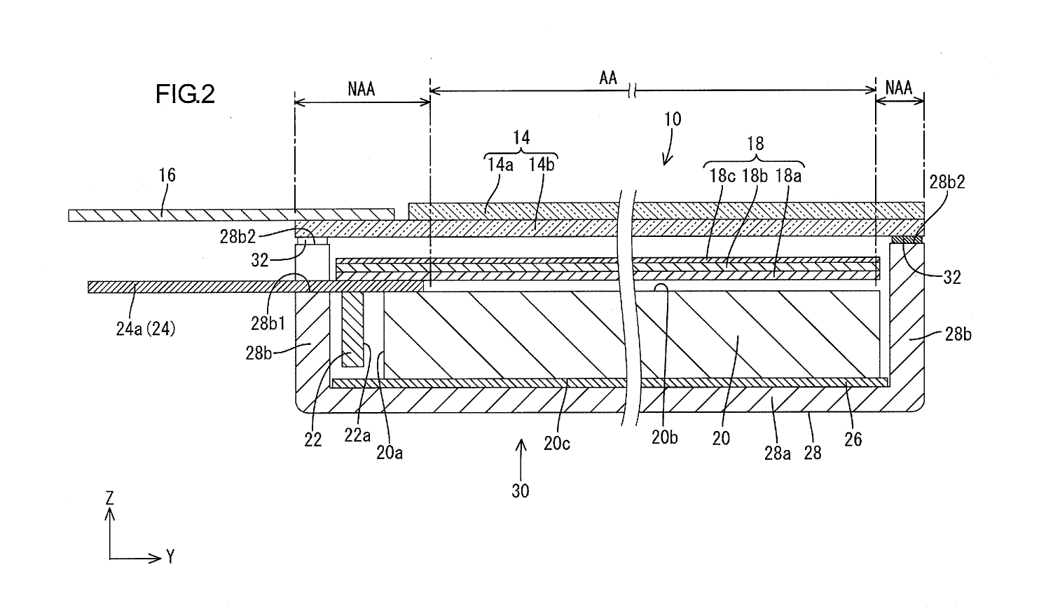

Side surfaces of the light guide plate 20 include side surfaces extending in the X-axis direction. One of the side surfaces extending in the X-axis direction (the left side in FIGS. 1 and 2) is a light entering surface 20a that is opposite the LEDs 22 mounted on the LED flexible circuit board 24, which will be described later. Light emitted from the LEDs 22 enters the light guide plate 20 through the light entering surface 20a. As illustrated in FIGS. 2 and 3, the light guide plate 20 is arranged in the chassis 28 such that the side surfaces of the light guide plate 20 except the light entering surface 20a are adjacent to the corresponding side plates 28b of the chassis 28. The light guide plate 20 is configured to receive light emitted from the LEDs 22 through the light entering surface 20a, transmit the light therethrough, and direct the light toward the optical member 18 (toward the front side, the light exit side). Light exits the light guide plate 20 through the light exit surface 20b. At least one of the light exit surface 20b and the opposite surface 20c of the light guide plate 20 or a front surface of the reflection sheet 26 includes a light scattering portion (not illustrated) which is configured to scatter the light in the light guide plate 20. The light scattering portion is formed by patterning to have a predetermined in-plane distribution. With the light scattering portion, light exits the light guide plate 20 through the light exit surface 20a with a uniform in-plane distribution.

The LED flexible circuit board 24 includes a film base member that is made of synthetic resin (e.g., polyimide resin) having insulating and flexible properties. The flexible circuit board 24 is located close to the light entering surface 20a of the light guide plate 20. The LED flexible circuit board 24 has a rectangular shape in a plan view. A long-side dimension and a short-side dimension of the LED flexible circuit board 24 correspond to the X-axis direction and the Y-axis direction, respectively. A front surface of the LED flexible circuit board 24 is on a side close to the liquid crystal panel 14 (the front side) and a rear surface of the LED flexible circuit board 24 is on a side close to the reflection sheet 26 (the rear side). The rear surface of the LED flexible circuit board 24 is configured as a mount surface on which multiple LEDs 22 are mounted. One of long-side edge portions of the LED flexible circuit board 24 is in contact with a portion of the light exit surface 20b of the light guide plate 20 close to the light entering surface 20a. That is, the LED flexible circuit board 24 is supported by the light guide plate 20.

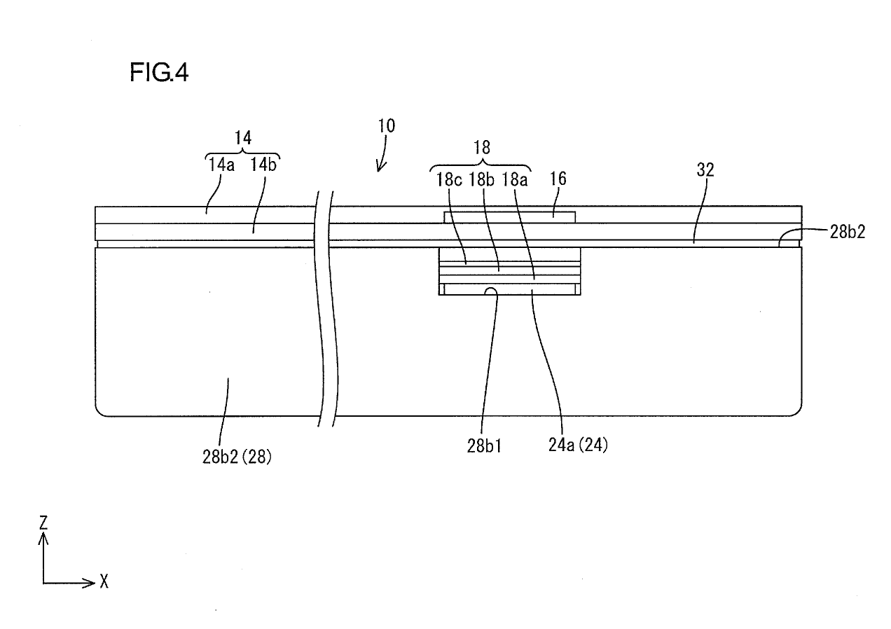

The LED flexible circuit board 24 includes an extending portion 24a that extends from a portion of the other long-side edge portion thereof toward an outer side with respect to the chassis 28. The extending portion 24a includes an unillustrated connection terminal at its distal end. When the liquid crystal display device 10 is arranged into a casing, a power supply circuit board is arranged into a gap in between the liquid crystal display device 10 and the casing. The connection terminal of the extending portion 24a is electrically connected to the power supply circuit board and thus power is supplied to the LEDs 22 and driving of the LEDs 22 is controlled. The extending portion 24a is supported by the notch 28b1 at a portion thereof, and the other large portion of the extending portion 24a protrudes outward with respect to the chassis 28 (see FIG. 2) through the notch 28b1 (see FIGS. 2 and 4). That is, in the chassis 28, the flexible circuit board 24 is supported such that the one of the long-side edge portions thereof is supported by the light guide plate 20 while the extending portion 24a that extends from the other long-side edge portion thereof is supported by the notch 28b1.

Multiple LEDs 22 are mounted in a line on the mount surface (the rear surface) of the LED flexible circuit board 24. Each LED 22 includes an LED chip (not illustrated) mounted on a board that is fixed on the LED flexible circuit board 24. The LED chip is sealed with resin. The LED chip mounted on the board has one main light emission wavelength. Specifically, the LED chip emits light in a single color of blue. The resin that seals the LED chip contains phosphors dispersed therein. The phosphors emit light in a predetermined color when excited by blue light emitted from the LED chip. Overall color of light emitted from the LED 22 is white. The phosphors may be selected, as appropriate, from yellow phosphors that emit yellow light, green phosphors that emit green light, and red phosphors that emit red light. The phosphors may be used in combination of the above phosphors. The LED 22 includes a surface mounted on the LED flexible circuit board 24 and the surface is defined as a front surface (or a rear surface). The LED 22 further includes side surfaces and one of the side surfaces is a light emitting surface 22a. That is, the LEDs 22 are so-called side-emitting type LEDs. The light emitting surface 22a of each LED 22 that is mounted on the mount surface of the LED flexible circuit board 24 is adjacent to the light entering surface 20a of the light guide plate 20. The LEDs 22 are arranged in a line (i.e., linearly) on the LED flexible circuit board 24 at predetermined intervals along the long-side dimension of the LED flexible circuit board 24 (the X-axis direction). That is, the LEDs 22 are arranged away from each other at one of edge portions of the backlight device 30 along the long-side dimension of the LED flexible circuit board 24 (the X-axis direction). The LEDs 22 mounted on the LED flexible circuit board 24 are adjacent to one of the side plates 28b of the chassis 28.

The optical member 18 has flexibility and, as illustrated in FIG. 1, has a rectangular shape in a plan view similar to the liquid crystal panel 14. Dimensions of the optical member 18 are substantially equal to those of the reflection sheet 26 and the bottom plate 28a of the chassis 28. The optical member 18 is opposite the entire area of the light exit surface 20a of the light guide plate 20. Peripheral edges of the optical member 18 are adjacent to the corresponding side plates 28b of the chassis 28. One of two short edge portions of the optical member 18 (close to the light entering surface 20a) is placed on a front surface of the LED flexible circuit board 24. As illustrated in FIG. 3, sheet fixing adhesive members 34 having light blocking properties are attached on long edge portions of the optical member 18 on the front surface. The sheet fixing adhesive members 34 stick on inner surfaces of the corresponding side plates of the chassis. Accordingly, the optical member 18 is fixed to the inner surfaces of the side plates 28b of the chassis (see FIG. 3). Since the optical member 18 is fixed to the side plates 28b of the chassis 28 with the sheet fixing adhesive members 34, the optical member 18 is slightly separated from the liquid crystal panel 14. The optical member 18 is located between the liquid crystal panel 14 and the light guide plate 20 and configured to pass incident light from the light guide plate 20 toward the liquid crystal panel 14. Specific optical properties are added to the light passing through the optical member 18. The optical member 18 includes multiple sheet-like members that are layered one another. Examples of the optical member 18 include a diffuser sheet, a lens sheet, and a reflecting type polarizing sheet. The optical sheets may be selected from those as appropriate.

Fixing structures of the liquid crystal panel 14 to the chassis 28 will be described with reference to FIGS. 2 and 3. The liquid crystal panel 14 has dimensions that are substantially equal to outer dimensions of the chassis 28 that has substantially a tray-like shape. A panel fixing adhesive (an example of adhesive) 32 having light blocking properties is applied on an edge surface of each side plate 28b (hereinafter, referred to as an edge surface 28b2). More specifically, the panel fixing adhesive 32 is applied over an entire area of the edge surface 28b2 of each side plate 28b except the portion having the notch 28b1. The side plates 28b of the chassis 28 have a small thickness and thus a double-sided tape cannot be disposed on the edge surface 28b2. However, the panel fixing adhesive 32 is a shapeless material and thus can be applied on the edge surface 28b2. The panel fixing adhesive 32 is applied over substantially an entire area of edge portions of the liquid crystal panel 14 and thus the liquid crystal panel 14 is fixed to the chassis 28, namely, the backlight device 30. The liquid crystal panel 14 that is fixed on the chassis 28 covers the opening of the backlight device 30. As illustrated in FIG. 2, in a state that the liquid crystal panel 14 is fixed on the chassis 28, a large portion of the panel flexible circuit board 16 mounted on the liquid crystal panel 14 is outside the chassis 28. When the liquid crystal display device 10 is arranged into the casing, a driver circuit board is arranged into a space provided between the liquid crystal display device 10 and the casing. A terminal at a tip of the panel flexible circuit board 16 is electrically connected to the driver circuit board and thus image data and various control signals are transmitted from the driver circuit board to the liquid crystal panel 14.

As illustrated in FIGS. 2 and 3, the liquid crystal panel 14 includes a display area AA and a non-display area NAA. The display area AA is an inner area of a screen in which images are displayed. The non-display area NAA is an outer area of the screen around the display area AA and has a frame-like shape (or a picture frame-like shape). In the liquid crystal display device 10 according to this embodiment, following components are arranged in the chassis 28 such that the peripheral edges of the reflection sheet 26, the side surfaces of the light guide plate 20 except the light entering surface 20a, and peripheral edges of the optical member 18 are adjacent to the corresponding side plates 28b of the chassis 28. In this configuration, most of an opening area of the chassis 28 corresponds to the display area AA. Further, the dimensions of the liquid crystal panel 14 are substantially equal to the outer dimensions of the chassis 28 and the side plate 28b of the chassis 28 has a small thickness. According to this configuration, a large part of the liquid crystal panel 14 corresponds to the display area AA and the size of the non-display area NAA is reduced. Thus, the width of the frame portion of the liquid crystal display device 10 is reduced. Namely, the liquid crystal display device 10 having a smaller frame size is obtained.

Next, steps of arranging components into the chassis 28 during manufacturing of the liquid crystal display device 10 will be described. First, the reflection sheet 26 is arranged into the chassis 28. The reflection sheet 26 has a size substantially equal to that of the bottom plate 28a of the chassis 28. Thus, when arranging the reflection sheet 26 into the chassis 28, the position of the reflection sheet 26 is determined by the inner surfaces of the respective side plates 28b of the chassis 28. Next, the light guide plate 20 is arranged into the chassis 28. When arranging the light guide plate 20 into the chassis 28, three of the side surfaces of the light guide plate 20 except the light entering surface 20a are positioned close to the respective inner surfaces of the respective side plates 28b of the chassis 28. Accordingly, the position of the light guide plate 20 in the chassis 28 is determined. Next, the LED flexible circuit board 24 including the LEDs 22 thereon is arranged in the chassis 28 and then the optical member 18 is arranged in the chassis 28. The optical member 18 has the size substantially equal to the bottom plate 28a of the chassis 28. Thus, when arranging the optical member 18 into the chassis 28, the position of the optical member 18 is determined by the inner surfaces of the respective side plates 28b of the chassis 28. After the optical member 18 is arranged in the chassis 28, the optical member 18 is fixed to the chassis 28 with the sheet fixing adhesive members 34. As described above, according to the manufacturing process of the liquid crystal display device 10, positions of the reflection sheet 26, the light guide plate 20, and the optical member 18 with respect to the chassis 28 are determined while being arranged into the chassis 28. Further, in the liquid crystal display device 10, the optical member 18 is fixed to the chassis 28 with the sheet fixing adhesive members 34. Accordingly, the components arranged on the rear side of the optical member 18, namely, the LED flexible circuit board 24, the light guide plate 20, and the reflection sheet 26 are held between the optical member 18 and the bottom plate 28a of the chassis 28.

As is described above, in the liquid crystal display device 10 according to this embodiment, the light guide plate 20 is arranged in the chassis 28 such that the side surfaces thereof except the light entering surface 20a are adjacent to the corresponding side plates 28b of the chassis 28. That is, the light exit surface 20b of the light guide plate 20 corresponds to a larger area in the chassis 28. The liquid crystal panel 14 and the optical member 18 are arranged so as to face the light exit surface 20b of the light guide plate 20. Thus, the display area AA of the liquid crystal panel 14 corresponds to a larger area in the chassis 28. Further, the chassis 28 is made of metal and thus the side plate 28b of the chassis 28 is processed to have an effectively smaller thickness in the manufacturing process. Furthermore, the liquid crystal panel 14 is fixed to the edge surfaces 28b2 of the side plates 28b via the panel fixing adhesive 32. That is, the liquid crystal panel 14 can be fixed to a portion having a smaller width, which is the edge surface 28b2. This reduces the width of a portion of the liquid crystal panel 14 used for fixing, namely, reduces the width of the non-display area NAA of the liquid crystal panel 14. As described above, in the liquid crystal display device 10 according to this embodiment, the width of the non-display area NAA of the liquid crystal panel 14 is reduced while the percentage of the display area AA of the liquid crystal panel 14 occupying in the area of the chassis 28 is increased. As a result, the frame size of the liquid crystal display device 10 is reduced.

In this embodiment, one of the side plates 28b of the chassis 28 includes the notch 28b1. The LED flexible circuit board 24 includes the extending portion 24a that extends from a portion of the LED flexible circuit board 24 toward outside with respect to the chassis 28. The extending portion 24a is through the notch 28b1. According to this configuration, the frame size of the liquid crystal display device 10 is reduced, whereas the extending portion 24a of the LED flexible circuit board 24 can be arranged so as to extend outward with respect to the chassis 28.

The panel fixing adhesive 32 of this embodiment has light blocking properties. Thus, light does not or is less likely to leak through a gap between the liquid crystal panel 14 and the chassis 28.

### First Modification of the First Embodiment

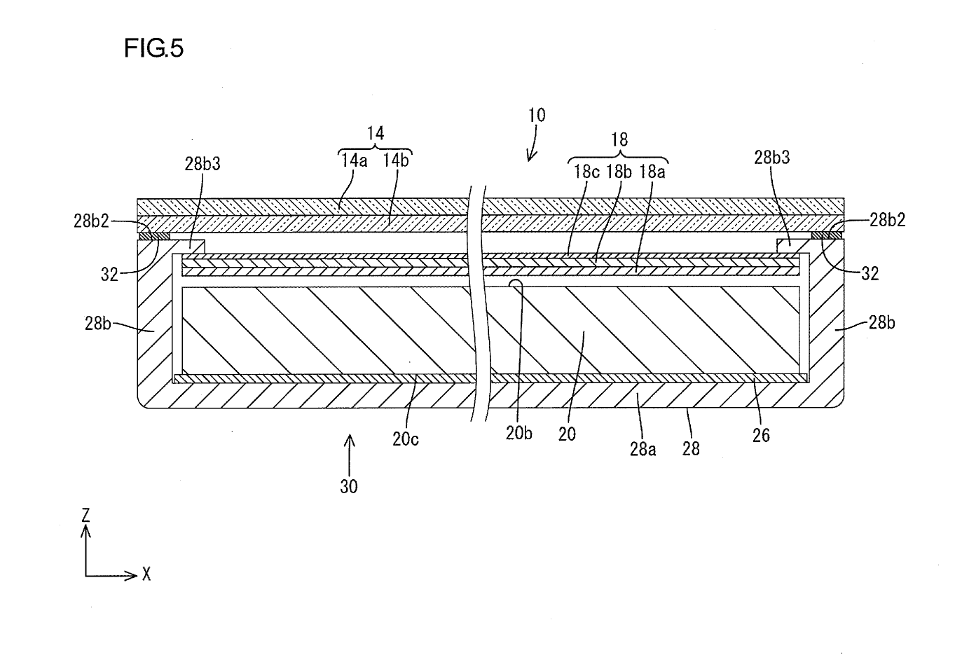

A first modification of the first embodiment will be described. In the liquid crystal display device 10 according to the first modification, a fixing structure of the optical member 18 to chassis 28 differs from the one in the first embodiment. Other configurations are similar to those in the first embodiment and thus similar configurations, operations, and effects to the first embodiment will not be described. As illustrated in FIG. 5, in the first modification of the first embodiment, two of the side plates 28b of the chassis 28 include bent portions 23b3. Specifically, the side plate 28b extending from the long edge of the bottom plate 28a includes the bent portion 23b3 at its distal end. Each bent portion 28b3 is bent inward. The bent portion 28b3 is formed by pressing and bending the distal end of the side plate 28b to make a right angle with respect to the side plate 28b. The bent portions 28b3 are in contact with portions of the front surface of the optical member 18 close to corresponding long edges of the optical member 18. Thus, the optical member 18 is fixed to the side plates 28b of the chassis 28. As described above, two of the side plates 22b of this embodiment each include the bent portion 28b3 at the distal end and the bent portion 28b3 is bent inward. Thus, the optical member 18 is fixed to the side plates 28b without using adhesive.

### Second Modification of the First Embodiment

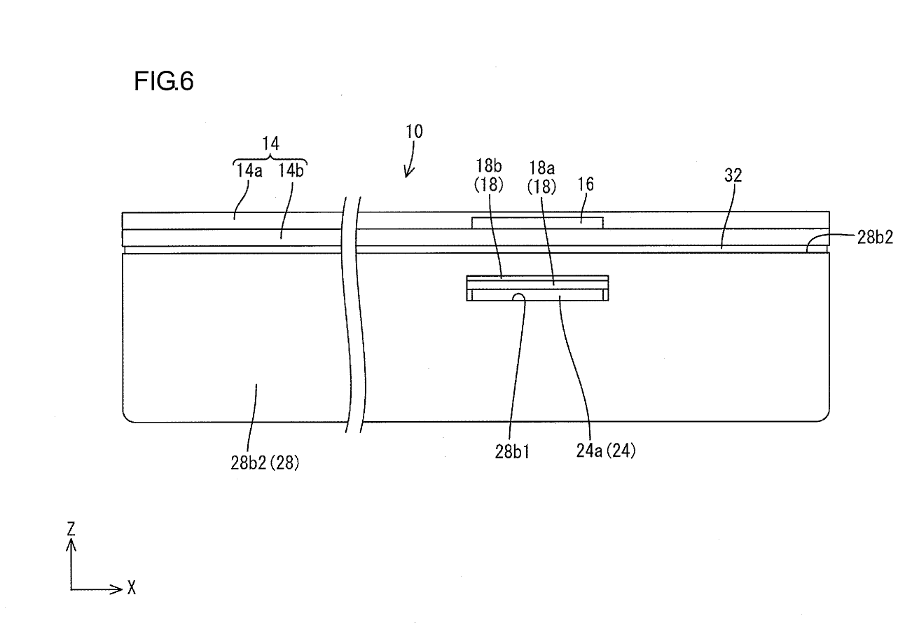

A second modification of the first embodiment will be described. In the liquid crystal display device 10 according to the second modification, a configuration of the side plates 28b of the chassis 28 partially differs from the one in the first embodiment. Other configurations are similar to those in the first embodiment and thus similar configurations, operations, and effects to the first embodiment will not be described. In the second modification of the first embodiment, as illustrated in FIG. 6, one of the side plates 28b of the chassis 28 includes a through hole 28b1 that extends therethrough. The position of the through hole 28b1 overlaps the extending portion 24a of the LED flexible circuit board 24 with respect to the long-side direction of the chassis 28 (the Y-axis direction). The extending portion 24a is through the through hole 28b1 while being supported by an inner surface of the through hole 28b1 formed in the side plate 28b of the chassis 28. In this embodiment, the side plate 28b of the chassis 28 includes the through hole 28b1 through which the extending portion 24a of the LED flexible circuit board 24 runs. Thus, the panel fixing adhesive 32 can be applied on a portion of the side plate 28b above the through hole 28b1 (the front side). That is, the panel fixing adhesive 32 can be applied on substantially the entire area in the edge surfaces of the side plates 28b of the chassis 28. Therefore, adhesion strength between the liquid crystal panel 14 and the chassis 28 is increased.

### Second Embodiment

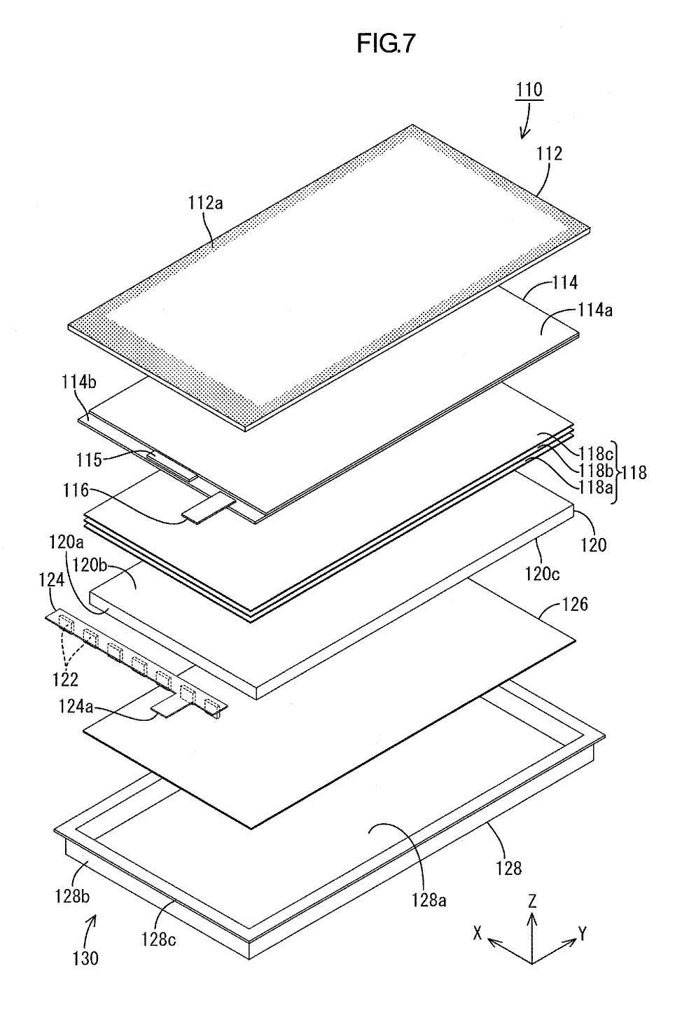

A second embodiment will be described with reference to drawings. A liquid crystal display device 110 is different from the first embodiment in that the liquid crystal display device 110 according to the second embodiment includes a cover panel 112. Further, fixing structures of a liquid crystal panel 114 to a chassis 128 differs from the one in the first embodiment. Other configurations are similar to the first embodiment and thus similar configurations, operations, and effects to the first embodiment will not be described. In FIGS. 7, 8, 9, and 10, portions indicated by numerals including the reference numerals in FIGS. 1, 2, 3, and 4 with 100 added thereto have the same configurations as the portions indicated by the respective reference numerals in the first embodiment.

As illustrated in FIG. 7, the liquid crystal display device 110 according to the second embodiment includes the cover panel (an example of a protector) 112. The cover panel 112 faces a front surface of the liquid crystal panel 114. The cover panel 112 covers an entire area of the front surface of the liquid crystal panel 114 and thus protects the liquid crystal panel 114. Specifically, an entire surface of the liquid crystal panel 114 is bonded to an inner portion of a rear plate surface of the cover panel 112 with an adhesive (not illustrated). The cover panel 112 has a rectangular shape similar to the liquid crystal panel 114 and has a plan size slightly larger than that of substrates 114a, 114b of the liquid crystal panel 114. That is, edge portions of the cover panel 112 protrude outward, such as eaves, with respect to corresponding edges of the liquid crystal panel 114. A light blocking portion 112a is formed along a periphery of the cover panel 112. Specifically, the light blocking portion 112a is formed by printing methods such as screen printing and inkjet printing. The light blocking portion 112a is formed on edge portions of the cover panel 112 that protrude outward with respect to the corresponding edges of the liquid crystal panel 114, that is, the light blocking portion 112a has a substantially rectangular and vertically long shape (a frame-like shape). Accordingly, light from a backlight device 130 is blocked by the light blocking portion 112a before the light around the liquid crystal panel 114 enters the cover panel 112 through a rear surface of the cover panel 112.

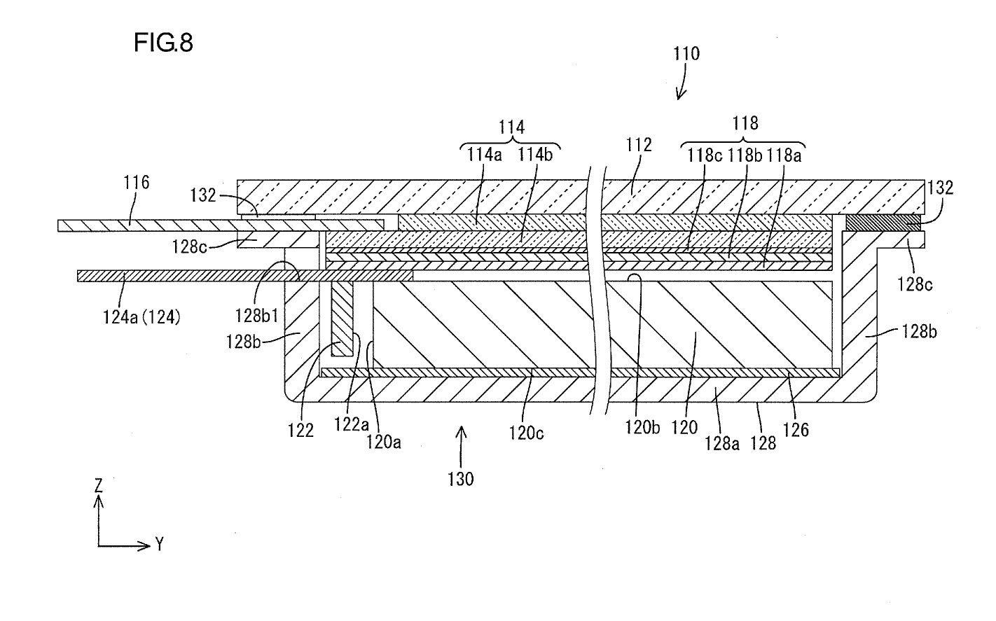

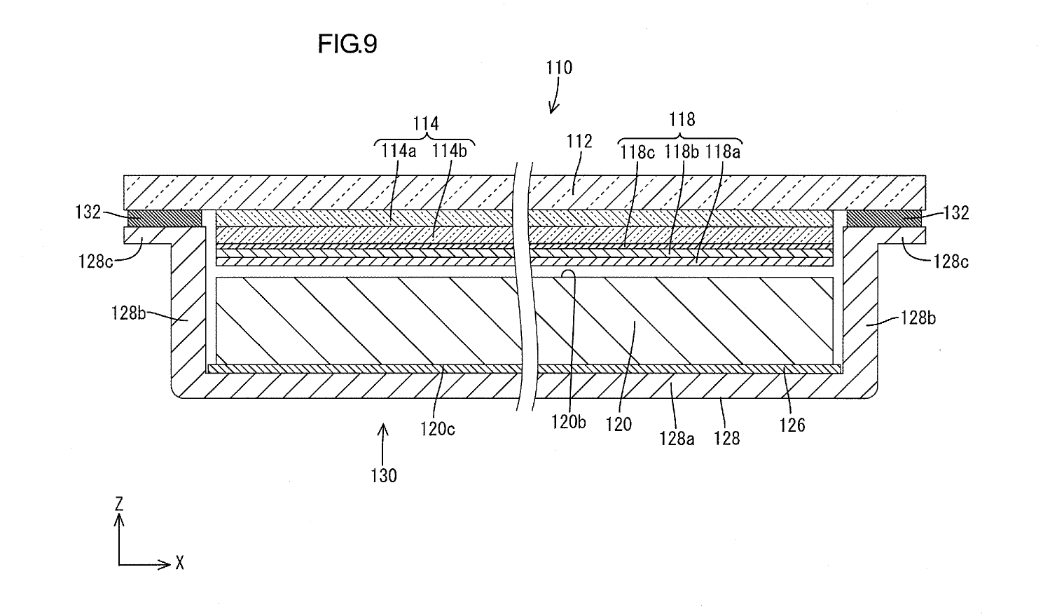

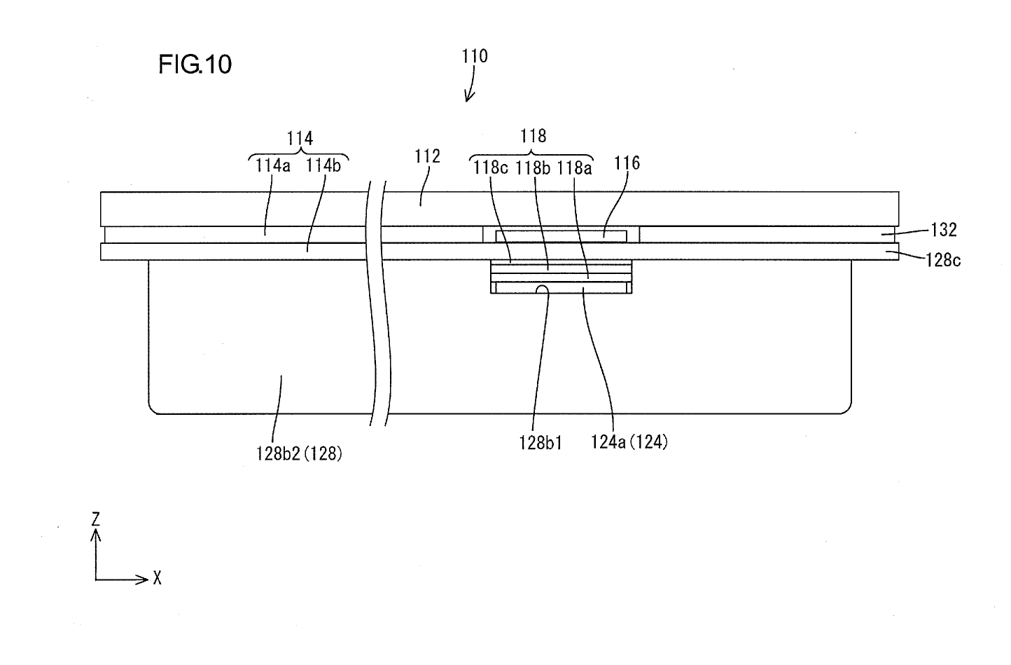

As illustrated in FIG. 7, in the liquid crystal display device 110 according to this embodiment, side plates 128b of the chassis 128 include overhanging portions 128c. Each of the overhanging portions 128 extends outward from its distal end. A cover fixing adhesive 132 is applied on a substantially entire area of a front surface of each overhanging portion 128c. As illustrated in FIGS. 8 and 9, a peripheral portion of the cover panel 112 is bonded to the cover fixing adhesive 132 over substantially its entire area. Thus, the cover panel 112 is fixed to and supported by the chassis 128, namely, the backlight device 130. The liquid crystal panel 114 is fixed to the cover panel 112 such that an entire front surface thereof is bonded to the cover panel 112 with an adhesive (not illustrated). The cover fixing adhesive 132 is not applied at a portion of the overhanging portion 128c near a panel flexible circuit board 116. Accordingly, the panel flexible circuit board 116 is through a hole defined by the overhanging portion 128c, the cover fixing adhesive 132, and the cover panel 112. A large portion of the panel flexible circuit board 116 extends outward with respect to the chassis 128 (see FIG. 10). According to the configuration in which the liquid crystal panel 114 is fixed to the cover panel 112 as described above, adhesion strength remains high between the liquid crystal panel 114 and the cover panel 112 and thus the cover panel 112 is not or less likely to be displaced with respect to the liquid crystal panel 114. An optical member 118 is bonded to the liquid crystal panel 114 with an unillustrated adhesive such that an entire front surface of the optical member 118 is attached to the liquid crystal panel 114. Thus, the liquid crystal panel 114 is fixed to the optical member 118.

In the liquid crystal display device 110 according to this embodiment, the liquid crystal panel 114 is protected by the cover panel 112 while the frame size of the liquid crystal display device 110 is reduced. Further, the side plate 128b of the chassis 128 includes the overhanging portion 128c at the distal end thereof. Thus, the side plate 128b allocates a sufficient area to support and hold the cover panel 112. According to this configuration, an agent such as a double-sided tape, which is a different agent from an adhesive, can be attached to the overhanging portion 128c. Accordingly, the cover panel 112 is effectively supported and held by the side plates 128b of the chassis 128.

### Third Embodiment

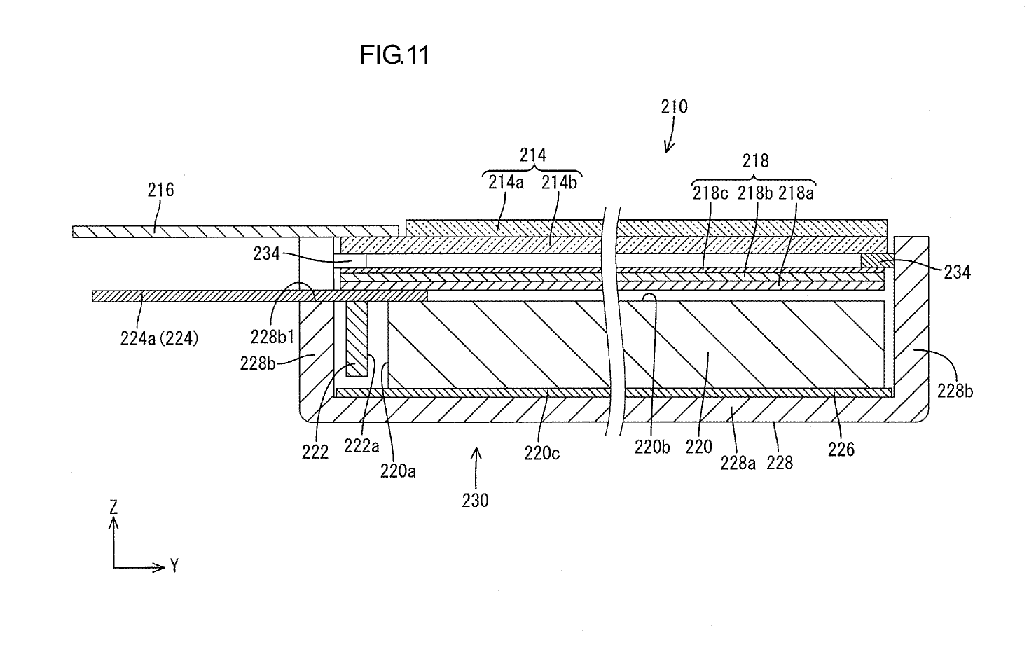

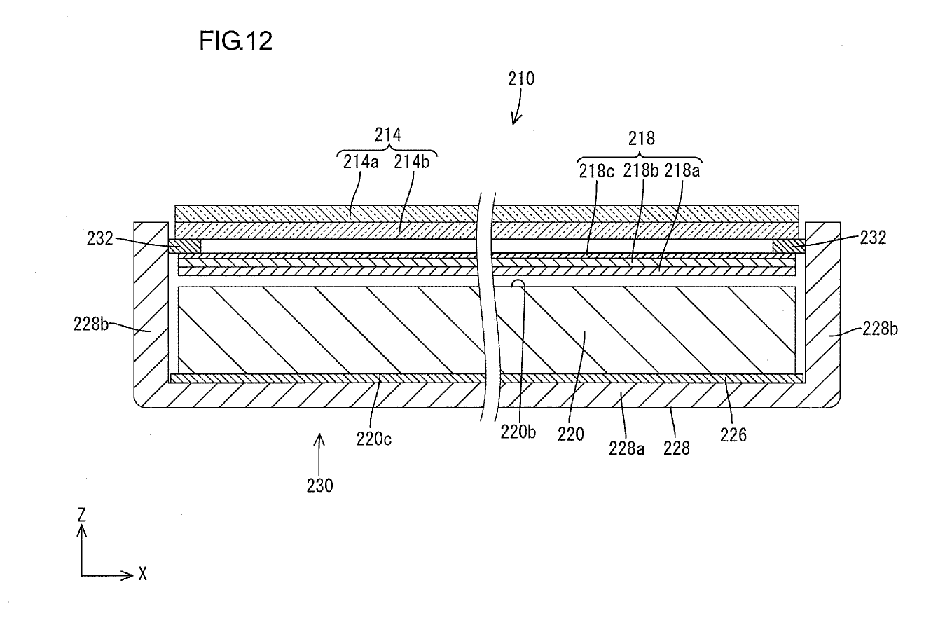

A third embodiment will be described with reference to drawings. A fixing structure of a liquid crystal panel in the third embodiment differs from the one in the first embodiment. Other configurations are similar to the first embodiment and thus similar configurations, operations, and effects to the first embodiment will not be described. In FIGS. 11 and 12, portions indicated by numerals including the reference numerals in FIGS. 2 and 3 with 200 added thereto have the same configurations as the portions indicated by the respective reference numerals in the first embodiment.

As illustrated in FIGS. 11 and 12, in a liquid crystal display device 210 according to the third embodiment, a liquid crystal panel 214 is on a sheet fixing adhesive (an example of an adhesive) 234 that fixes an optical member 218 to side plates 228b of a chassis 228. Specifically, edge portions of the liquid crystal panel 214 on its rear surface are attached to the sheet fixing adhesive 234. That is, the sheet fixing adhesive 234 is between the optical member 218 and the liquid crystal panel 214 and is located on inner surfaces of the corresponding side plates 228b of the chassis 228. Thus, each of the optical member 218 and the liquid crystal panel 214 is fixed to the side plates 228b of the chassis 228 via the sheet fixing adhesive 234. In this embodiment, since the liquid crystal panel 214 is fixed as described above, the adhesive to fix the liquid crystal panel 214 to the side plates 228b of the chassis 228 can be used as an agent to fix the optical member 218 to the side plates 228b of the chassis 228. Accordingly, space for an adhesive can be saved and thus the frame size of the liquid crystal display device 210 is further reduced.

Modifications of the above embodiments will be described.

(1) In each of the above embodiments, the extending portion of the LED flexible circuit board is through the notch or the through hole formed in one of the side plates of the chassis and extends outside with respect to the chassis. However, configurations to extend the extending portion of the LED flexible board outside with respect to the chassis are not limited to those in the above embodiments.

(2) In each of the above embodiments, one of the side surfaces of the light guide plate is configured as a light entering surface. However, multiple side surfaces of the light guide plate may be configured as light entering surfaces. In that case, multiple LED flexible boards may be disposed such that LEDs mounted thereon are opposite the corresponding light entering surfaces.

(3) In each of the above embodiments, the optical member is fixed to the chassis or the liquid crystal panel with respect to a thickness direction of the liquid crystal display device. However, it is not necessary to fix the optical member to the liquid crystal display device with respect to the thickness direction of the liquid crystal display device.

(4) The liquid crystal display devices of each of the above embodiments include a liquid crystal panel classified into a small size or a medium size. However, the aspect of this invention can be applied to liquid crystal display devices including a liquid crystal panel classified into a large size.

(5) The liquid crystal display devices of each of the above embodiments includes a liquid crystal display panel configured as a display panel. However, the aspect of this invention can be applied to display devices including other types of display panels.

Details of the embodiments of the invention are as described above. However, the above embodiments are only some examples and the scope of the claimed invention is not limited thereto. The technical scope of the claimed invention includes various modifications of the above embodiments.

### EXPLANATION OF SYMBOLS

10, 110, 210; liquid crystal display device, 14, 114, 214; liquid crystal panel, 16, 116, 216; panel flexible circuit board, 18, 118, 218; optical member, 20, 120, 220; light guide plate, 24, 124, 224; LED flexible circuit board, 28, 128, 228; chassis, 28b, 128b, 228b; side plate (of chassis), 28b3; bent portion, 30, 130, 230; backlight device, 32; panel fixing adhesive, 34, 234; sheet fixing adhesive, 112; cover panel, 128c; overhanging portion, 132; cover fixing adhesive.

1: A display device comprising:
a light source;
a light guide plate including a plate surface configured as a light exit surface, another plate surface as an opposite surface opposite from the light exit surface, and one of side surfaces configured as a light entering surface, the light guide plate being arranged such that the light entering surface is opposite the light source and configured to guide light from the light source;
a housing member made of metal and including a bottom plate and side plates, the bottom plate having a plate-like shape and facing the opposite surface, the side plates each having a plate-like shape extending from corresponding edges of the bottom plate toward the light exit surface, the housing member holding at least the light guide plate such that the side surfaces of the light guide plate except the light entering surface are adjacent the corresponding side plates;
an optical member facing the light exit surface and being configured to add optical properties to light exiting through the light exit surface; and
a display panel facing a surface of the optical member opposite from a surface of the optical member facing the light exit surface, the display panel being fixed to at least one of the optical member and edges of the respective side plates with an adhesive.

2: The display device according to claim 1, wherein the optical member is fixed to the side plates.

3: The display device according to claim 2, wherein the adhesive is between the optical member and the display panel and on an inner side with respect to the side plates, and the optical member and the display panel are fixed to the side plates with the adhesive.

4: The display device according to claim 2, wherein
the side plates include bent portions at the respective edges thereof, the bent portions protruding inward, and
the optical member is held by the bent portions of the side plates.

5: The display device according to claim 1, further comprising a protector on a surface of the display panel opposite from a surface of the display panel facing the optical member.

6: The display device according to claim 5, wherein
the side plates include overhanging portions at the edges thereof, the overhanging portions protruding outward, and
the protector is supported by the overhanging portions.

7: The display device according to claim 5, wherein an entire surface of the liquid crystal panel is bonded and fixed to the protector.

8: The display device according to claim 1, wherein
the light source is a side-emitting light source, and
the display device further comprises a light source board that has a plate surface on which the light source is mounted such that a light emitting surface of the light source faces the light entering surface, an edge portion of the plate surface of the light source board being in contact with an edge portion of the light exit surface close to the light entering surface.

9: The display device according to claim 8, wherein
one of the side plates includes a through hole, and
the light source board is a flexible board having flexibility and includes an extending portion extending outward with respect to the housing member, the extending portion being through the through hole.

10: The display device according to claim 1, wherein the adhesive has a light blocking property.

11: The display device according to claim 1, wherein the display panel is a liquid crystal panel including liquid crystals.
